(19) United States
(12) Patent Application Publication
(10) Pub. No.: US 2026/0316818 A1
(43) Pub. Date: Oct. 15, 2026

(54) STEERING DEVICE AND DETECTION DEVICE

(71) Applicant: ALPS ALPINE CO., LTD., Tokyo (JP)

(72) Inventors: Kazuma HORIE, Miyagi (JP); Hiromi MOTOI, Miyagi (JP); Takeshi MASAKI, Miyagi (JP)

(21) Appl. No.: 19/706,112

(22) Filed: Jun. 12, 2026

Related U.S. Application Data
(63) Continuation of application No. PCT/JP2023/047249, filed on Dec. 28, 2023.

(51) Int. Cl. B62D 1/06; B62D 1/08

(52) U.S. Cl. CPC B62D 1/06; B62D 1/08

(57) ABSTRACT

A steering device includes a rim portion configured to be gripped by a driver, a spoke portion disposed adjacent to the rim portion, and an electrostatic detector configured to detect a state of gripping of the rim portion by the driver based on a change in capacitance. The electrostatic detector includes a detection electrode and an active shield electrode, and both of the detection electrode and the active shield electrode are provided in the spoke portion so as to face the rim portion. The spoke portion is provided with a drainage path configured to guide water to a drainage hole when the spoke portion is exposed to water. The drainage hole, the active shield electrode, the detection electrode, and the rim portion are arranged, in this order, from a region in the vicinity of the drainage hole toward the rim portion.

### CROSS-REFERENCE TO RELATED APPLICATIONS

This application is a continuation application of International Application No. PCT/JP2023/047249 filed on Dec. 28, 2023, and designating the U.S., the entire contents of which are incorporated herein by reference.

### BACKGROUND

### 1. Technical Field

The present invention relates to a steering device and a detection device.

### 2. Description of Related Art

International Publication No. WO 2020/195620 (hereinafter “Patent Document 1”) discloses a technology for detecting whether a driver's hand is present in the vicinity of or in contact with a steering wheel by detection of a capacitive sensor provided on a spoke portion of the steering wheel.

### SUMMARY

A steering device according to an embodiment includes a rim portion configured to be gripped by a driver, a spoke portion disposed adjacent to the rim portion, and an electrostatic detector configured to detect a state of gripping of the rim portion by the driver based on a change in capacitance. The electrostatic detector includes a detection electrode and an active shield electrode, both of the detection electrode and the active shield electrode being provided in the spoke portion so as to face the rim portion. The spoke portion is provided with a drainage path configured to guide water to a drainage hole when the spoke portion is exposed to water. The drainage hole, the active shield electrode, the detection electrode, and the rim portion are arranged, in this order, from a region in the vicinity of the drainage hole toward the rim portion. A base having a sheet-like shape, flexibility, and insulating properties is stacked between the detection electrode and the active shield electrode of the electrostatic detector. The base is composed of at least an intermediate member made of rubber.

### BRIEF DESCRIPTION OF THE DRAWINGS

FIG. 1 is a plan view of a steering device according to an embodiment;

FIG. 2 is an external perspective view of a detection device according to the embodiment;

FIG. 3 is an exploded perspective view of the detection device according to the embodiment;

FIG. 4 is a cross-sectional view schematically illustrating a stack structure of an electrostatic detector included in the detection device according to the embodiment;

FIG. 5 is a diagram illustrating a configuration of a control system included in the detection device according to the embodiment;

FIG. 6 is a partially enlarged perspective view of the detection device according to the embodiment;

FIG. 7 is a plan view of the detection device according to the embodiment viewed from a positive Y-axis direction;

FIG. 8A is a diagram illustrating a comparative example for the electrostatic detector according to the embodiment;

FIG. 8B is a schematic diagram illustrating a first example of the electrostatic detector according to the present embodiment; and

FIG. 8C is a schematic diagram illustrating a second example of the electrostatic detector according to the embodiment.

### DETAILED DESCRIPTION

However, in the technology of Patent Document 1, when the spoke portion of the steering wheel is exposed to water, water capacitively couples with the capacitance sensor. As a result, the output value of the capacitance sensor exhibits significant variation, thereby making it difficult to accurately detect the presence of the driver's hand.

According to the steering device according to an embodiment, even when the spoke portion of the steering wheel is exposed to water, the driver's hand can be detected with high accuracy.

Hereinafter, an embodiment will be described with reference to the drawings.

### Configuration of Steering Device 10

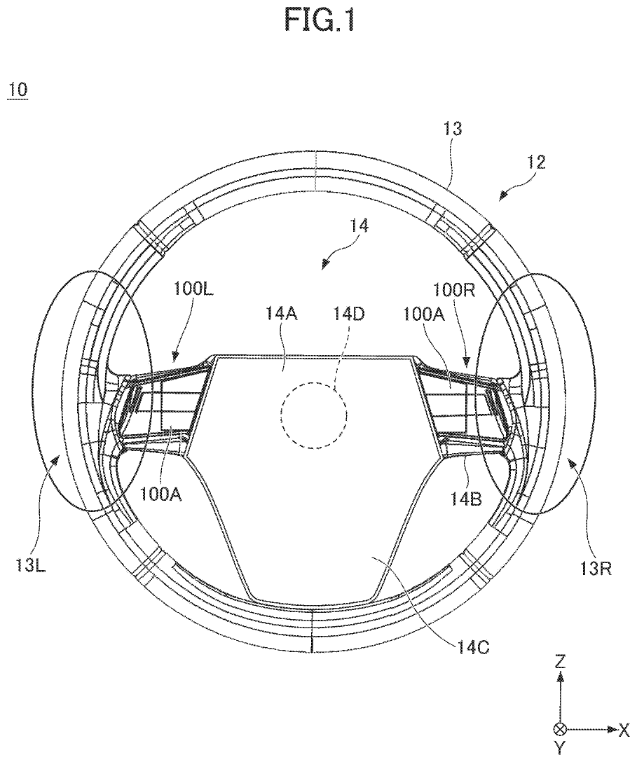

FIG. 1 is a plan view of a steering device 10 according to the present embodiment.

In the following description, for the sake of convenience, the X-axis direction is set to the left-right direction, the Y-axis direction is set to the front-rear direction, and the Z-axis direction is set to the up-down direction. However, the positive X-axis direction is set to the right direction, the positive Y-axis direction is set to the front direction, and the positive Z-axis direction is set to the upward direction. These are intended to indicate the relative positional relationship within the device, and are not intended to limit the installation direction or operation direction of the device. All devices having the same relative positional relationship within the device are included within the scope of the present invention, even if the installation direction or operation direction is different.

The steering device 10 illustrated in FIG. 1 is installed in the cabin of a vehicle, such as an automobile, and enables the driver to operate the steering wheel of the vehicle and perform switch operations.

As illustrated in FIG. 1, the steering device 10 includes a steering wheel 12 and two detection devices 100 (detection devices 100L and 100R).

The steering wheel 12 includes a rim portion 13 and a spoke portion 14. The rim portion 13 is an annular portion which is engaged by the fingers of the driver's hand to operate the steering wheel. Although illustration is omitted, a cross-sectional configuration of the rim portion 13 includes a rim core portion made of a metal and arranged at the center of the rim portion 13 and a covering portion made of a resin (e.g., urethane) and covering the outer surface of the rim core portion. The left-side (negative X-axis side) area of the rim portion 13 serves as a grip portion 13L engaged by the fingers of the driver's left hand. The right-side (positive X-axis side) area of the rim portion 13 serves as a grip portion 13R engaged by the fingers of the driver's right hand. Although both the steering wheel 12 and the rim portion 13 of the present embodiment are in an annular shape, the present invention is not limited to this, and may have various shapes, such as a shape in which only the lower portion is connected and the upper portion is cut off, or a part of the rim is linear.

The spoke portion 14 is provided in the center of the rim portion 13 and supports the rim portion 13 from a radially inner side. In the present embodiment, as an example, the spoke portion 14 includes a central portion 14A arranged at the center of the steering wheel 12, a first portion 14B extending along the left-right direction (X-axis direction) from the central portion 14A, a second portion 14C extending downward (Z-axis direction) from the central portion 14A. In other words, the spoke portion 14 has a substantially T-shape in a plan view.

The left (negative X-axis side) end portion of the first portion 14B of the spoke portion 14 is connected to the rim core portion of the rim portion 13 in the grip portion 13L area. The right (positive side of the X-axis) end portion of the first portion 14B of the spoke portion 14 is connected to the rim core portion of the rim portion 13 in the grip portion 13R area. The lower (negative Z-axis side) end of the second portion 14C of the spoke portion 14 is connected to the rim core portion of the rim portion 13. Thus, the spoke portion 14 supports the rim portion 13 from a radially inner side.

The spoke portion 14 is composed of a spoke core portion made of a metal and serving as a base portion of the spoke portion 14, a covering portion made of a resin (e.g., urethane) and covering a part of the outer surface of the spoke core portion, and functional components, such as a decorative cover, which is made of a resin and attached to the driver side surface of the spoke core portion, and a horn.

In the spoke portion 14, a through-hole 14D formed in the hub core portion of the central portion 14A, and the spoke portion 14 is fixed to a steering shaft (not illustrated) inserted into the through-hole 14D by a nut (not illustrated) or the like. Thus, the spoke portion 14 rotates together with the steering wheel 12 in accordance with a steering wheel operation, and the steering shaft can be rotated about the axis of the central axis.

The detection devices 100L and 100R are installed in the spoke portion 14 to receive various switch operations that are input by the driver. The detection device 100L is installed in the left side (negative X-axis) of the first portion 14B of the spoke portion 14. The detection device 100R is installed in the right side (positive X-axis side) of the first portion 14B of the spoke portion 14. The detection devices 100L and 100R are substantially rectangular in a plan view from the driver side (negative Y-axis side), and are symmetrical with respect to a plane passing through the center of the steering wheel 12. The surfaces of the detection devices 100L and 100R on the driver side (negative Y-axis side) are operation surfaces 100A with which the driver inputs various switch operations.

The detection device 100L is provided in the vicinity of the grip portion 13L of the rim portion 13. The detection device 100L can receive a switch operation on the operation surface 100A from the fingers of the driver's left hand engaging the grip portion 13L area. The detection device 100L can detect, in a non-contact manner, the gripping state of the grip portion 13L by the driver's left hand.

The detection device 100R is provided in the vicinity of the grip portion 13R of the rim portion 13. The detection device 100R can receive a switch operation on the operation surface 100A from the fingers of the driver's right hand engaging the grip portion 13R area. The detection device 100R can detect, in a non-contact manner, the gripping state of the grip portion 13R by the driver's right hand.

### Configuration of Detection Device 100

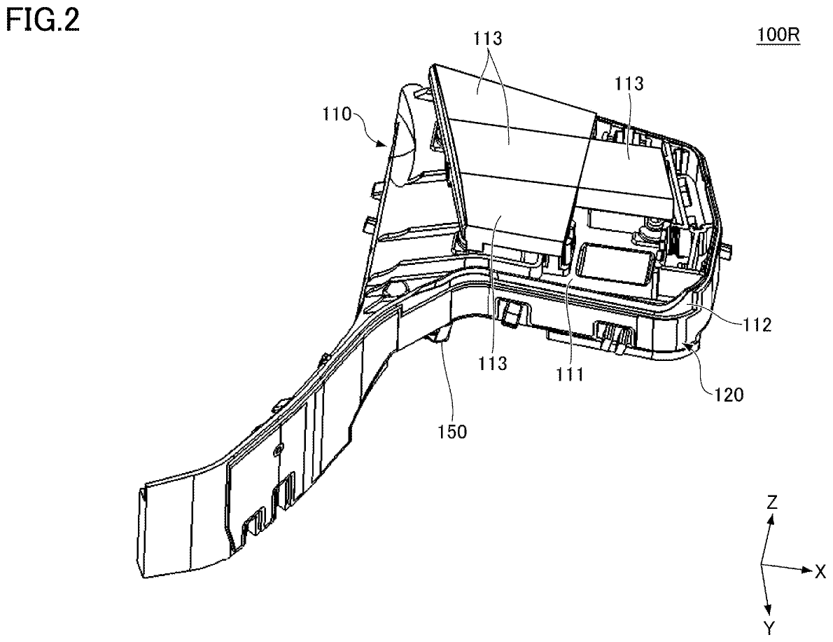

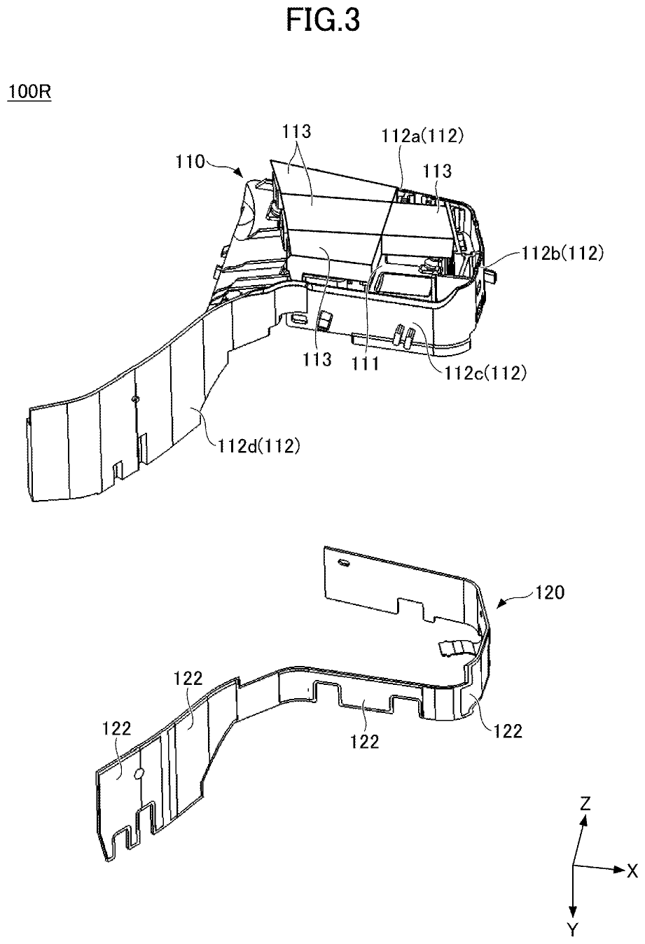

Hereinafter, the configuration of the detection device 100 will be described using the detection device 100R as a representative example. FIG. 2 is an external perspective view of the detection device 100R according to the present embodiment. FIG. 3 is an exploded perspective view of the detection device 100R according to the present embodiment.

As illustrated in FIGS. 2 and 3, the detection device 100R includes a housing 110 and an electrostatic detector 120.

The housing 110 is a resin-made, container-shaped member that is thin in the front-rear direction (Y-axis direction) and has an interior space. The housing 110 has a substantially rectangular shape in a plan view from the driver side (negative Y-axis side). The housing 110 includes a driver-facing wall portion 111 that closes off the driver-facing side (negative Y-axis side) of the interior space on, an outer peripheral wall portion 112 that surrounds the periphery of the interior space, and a bottom wall portion 150 that closes off the bottom surface side (positive Y-axis side) of the interior space.

The driver-facing wall portion 111 of the housing 110 faces the driver, with a panel (not illustrated) interposed between the driver-facing wall portion 111 and the driver. Operation knobs 113 of a plurality of switches (an example of a “switch input function”) are arranged in alignment on the driver-facing wall portion 111 of the housing 110. In other words, the surfaces of the operation knobs 113 define an operation surface 100A with which various switch operations are input. The surface of the driver-facing wall portion 111 of the housing 110 in the front direction (positive Y-axis direction) includes irregularities due to a drainage path 115 formed on the surface. However, a panel (not illustrated) is attached so as to cover the driver-facing wall portion 111 and the electrostatic detector 120, thereby forming a smooth operation surface 100A in cooperation with the surfaces of the operation knobs 113.

Although not illustrated, a circuit board and respective components (switch elements provided on the circuit board, actuators for interlocking operation knobs 113 and the switch elements, and the like) of a plurality of switches are provided in the interior space of the housing 110. Each of the plurality of operation knobs 113 is provided so as to penetrate the driver-facing wall portion 111 of the housing 110, and the switch elements provided on the circuit board can be operated through the actuators or the like when a switch operation is input by the driver.

As illustrated in FIG. 3, the outer peripheral wall portion 112 of the housing 110 includes an upper wall portion 112a, a right wall portion 112b, and a lower wall portion 112c provided so as to surround the upper side (positive Z-axis side), the right side (positive X-axis side), and the lower side (negative Z-axis side) of the driver-facing wall portion 111. Parts of the upper wall portion 112a, the right wall portion 112b, and the lower wall portion 112c are provided so as to project from the surface of the driver-facing wall portion 111 of the housing 110 to the driver side (negative Y-axis side).

The outer peripheral wall portion 112 of the housing 110 includes an extended wall portion 112d provided so as to extend the outer peripheral wall portion 112. The extended wall portion 112d is a wall-like portion extending downward (negative Z-axis direction) from the left end of the lower wall portion 112c of the outer peripheral wall portion 112 along the right side surface of the second portion 14C of the spoke portion 14.

The electrostatic detector 120 is a sheet-like sensor provided for detecting, in a non-contact manner, gripping of the grip portion 13R on the right side of the rim portion 13 by the driver's right hand by an electrostatic method. The electrostatic detector 120 has a strip-like shape as a whole. The electrostatic detector 120 is provided on the outer peripheral wall portion 112 of the housing 110.

Specifically, the electrostatic detector 120 is attached along the surfaces of the upper wall portion 112a, the right wall portion 112b, the lower wall portion 112c, and the extended wall portion 112d of the outer peripheral wall portion 112 of the housing 110 by a double-sided tape or the like. Thus, the electrostatic detector 120 is arranged to face the grip portion 13R of the rim portion 13 provided on the right side (in the positive direction of the X-axis) of the housing 110, and the fingers of the driver's right hand engaging the grip portion 13R can be detected in a non-contact manner.

Although the configuration of the detection device 100R has been described above, the configuration of the detection device 100L is substantially symmetrical to the configuration of the detection device 100R, and is essentially the same as the configuration of the detection device 100R.

### Stack Structure of Electrostatic Detector 120

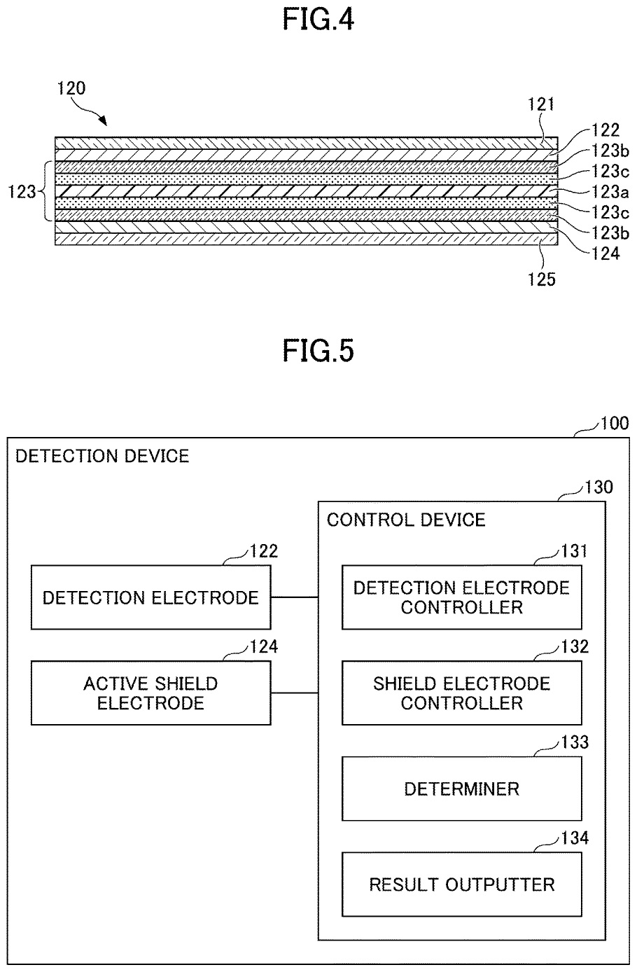

FIG. 4 is a cross-sectional view schematically illustrating a stack structure of the electrostatic detector 120 included in the detection device 100 according to the present embodiment. As illustrated in FIG. 4, the electrostatic detector 120 has a stack structure in which a coverlay 121, a detection electrode 122, a base 123, an active shield electrode 124, and a coverlay 125 are stacked in order from the surface side.

The base 123 is a flexible and insulating sheet-like member serving as a base of the electrostatic detector 120. In the example illustrated in FIG. 4, the base 123 has a structure in which a polyimide film 123b is attached to the front and rear surfaces of an intermediate material 123a, such as silicon rubber, with a double-sided tape 123c, respectively.

The detection electrode 122 is formed on the front surface of the base 123. The detection electrode 122 is provided for non-contact detection of the fingers of the driver's hand in the vicinity of the detection electrode 122 by an electrostatic capacitance method.

The active shield electrode 124 is formed on the rear surface of the base 123. The active shield electrode 124 is driven by a drive signal synchronized with a drive signal of the detection electrode 122, so that noise components applied to the detection electrode 122 from the rear side of the detection electrode 122 can be removed.

A thin-film conductor such as ITO (indium tin oxide), IZO (indium zinc oxide), or a metal film (e.g. composite materials of silver, copper, aluminum and molybdenum) is used as the detection electrode 122 and the active shield electrode 124.

The coverlay 121 is a resin-made, film-shaped member stacked on the front surface of the base 123 in a state where the detection electrode 122 is formed on the front surface of the base 123. The coverlay 125 covers the front surface of the base 123, thereby protecting the front surface of the base 123 and the detection electrode 122.

The coverlay 125 is a resin-made, film-shaped member stacked on the rear surface of the base 123 in a state where the active shield electrode 124 is formed on the rear surface of the base 123. The coverlay 125 covers the rear surface of the base 123, thereby protecting the rear surface of the base 123 and the active shield electrode 124.

The electrostatic detector 120 having a stack structure as described above is attached, at the rear surface of the electrostatic detector 120 (the surface on which the coverlay 125 is stacked), to the front surface of the outer peripheral wall portion 112 (upper wall portion 112a, right wall portion 112b, lower wall portion 112c, and extended wall portion 112d) of the housing 110. Thus, the electrostatic detector 120 is provided in such a manner that the detection electrode 122 and the active shield electrode 124 are arranged in the spoke portion 14 of the steering wheel 12 so as to be opposed to the grip portion 13R of the rim portion 13. Thus, the electrostatic detector 120 can detect the fingers of the driver's hand engaging the grip portion 13R by the detection electrode 122 in a non-contact manner. At this time, the electrostatic detector 120 can remove noise components applied to the detection electrode 122 from the housing 110 side, which is the rear side of the electrostatic detector 120 by the active shield electrode 124.

### Configuration of Control System Included in Detection Device 100

FIG. 5 is a diagram illustrating a configuration of a control system included in the detection device 100 according to the present embodiment. As illustrated in FIG. 5, the control system included in the detection device 100 includes the detection electrode 122 and the active shield electrode 124 described above, and a control device 130. The configuration of the control system of the detection device 100 illustrated in FIG. 5 is a configuration common to the detection devices 100L and 100R.

The control device 130 is a device capable of determining the presence or absence of the fingers of the driver's hand engaging the rim portion 13 (grip portion 13L or 13R) of the steering wheel 12 based on the detection result by the detection electrode 122, and outputting the determination result.

As illustrated in FIG. 5, the control device 130 is electrically connected to each of the detection electrode 122 and the active shield electrode 124. The control device 130 includes a detection electrode controller 131, a shield electrode controller 132, a determiner 133, and a result outputter 134.

The detection electrode controller 131 detects a change in capacitance at the detection electrode 122. Specifically, the detection electrode controller 131 drives the detection electrode 122 by applying an AC voltage consisting of a sine wave to the detection electrode 122 as a drive signal. The detection electrode 122 detects a change in the current value of the current flowing through the detection electrode 122 as a change in capacitance.

For example, the detection electrode 122 of the detection device 100R is provided in the vicinity of the grip portion 13R so as to face the grip portion 13R. For this reason, when the fingers of the driver's right hand engage the grip portion 13R, the fingers of the driver's right hand are present in the vicinity of the detection electrode 122 of the detection device 100R. Thus, the detection electrode 122 of the detection device 100R is capacitively coupled with the fingers of the driver's right hand, and the current value of the current flowing through the detection electrode 122 changes. Thus, the detection electrode 122 of the detection device 100R can detect the fingers of the driver's right hand (non-contact detection).

As illustrated in FIGS. 2 and 3, since the electrostatic detector 120 of the detection device 100R has a shape bent substantially at a right angle at the upper right corner portion of the housing 110 and the lower right corner portion of the housing 110, the fingers of the driver's right hand can be detected within a range of approximately ±30° in the grip portion 13R with the 90° position of the rim portion 13 (positive X-axis side) as a reference.

The shield electrode controller 132 generates an active shield signal and outputs the active shield signal to the active shield electrode 124. Thus, the shield electrode controller 132 drives the active shield electrode 124. The active shield signal is, for example, a signal (i.e., AC voltage consisting of a sine wave) having a waveform synchronized with a drive signal applied from the detection electrode controller 131 to the detection electrode 122. By being driven, the active shield electrode 124 can remove noise components applied to the detection electrode 122 from the rear side of the active shield electrode 124 (the housing 110 side). In other words, the active shield electrode 124 can remove noise components from a capacitance detected by the detection electrode 122.

The determiner 133 determines the presence or absence of the fingers of the driver's hand engaging the grip portion 13L or 13R based on a change in a capacitance of the detection electrode 122 detected by the detection electrode controller 131.

For example, the determiner 133 determines presence of the fingers of the driver's right hand engaging the grip portion 13R when a difference between a reference value and a capacitance value of the detection electrode 122 included in the detection device 100R is equal to or greater than a predetermined threshold value th.

On the other hand, the determiner 133 determines absence of the fingers of the driver's right hand engaging the grip portion 13R when a difference between a reference value and a capacitance value of the detection electrode 122 included in the detection device 100R is less than the predetermined threshold value th.

The reference value is set based on the assumption that the capacitance corresponds to a state in which the driver's fingers, or any other objects, are not near the grip portions 13L or 13R.

A suitable value obtained in advance by an actual machine test, simulation, or the like is used for the threshold value th. As described above, since the control device 130 drives the active shield electrode 124, a capacitance detected by the detection electrode 122 is a value obtained by removing noise components from the rear side of the detection electrode 122 (the housing 110 side). For this reason, in the present embodiment, since a value obtained by removing noise components from the rear side of the detection electrode 122 (the housing 110 side) by the active shield electrode 124 is used as the threshold value th, the value is lower than that in a conventional configuration in which the active shield electrode is not used.

The result outputter 134 outputs the determination result (i.e., the presence or absence of the driver's fingers engaging the grip portion 13L or 13R) by the determiner 133 to the outside (for example, a device that performs processing according to the result of determination by the determiner 133).

The control device 130 is implemented by, for example, a processor (for example, CPU (central processing unit)), a storage medium (for example, ROM (read only memory), RAM (random access memory), SSD (solid state drive), etc.), and a computer (for example, integrated circuits (ICs)) having an external interface or the like. For example, control processing in each functional unit of the control device 130 illustrated in FIG. 5 is implemented by the processor executing a program stored in the storage medium in the control device 130.

### Drainage Configuration of Detection Device 100

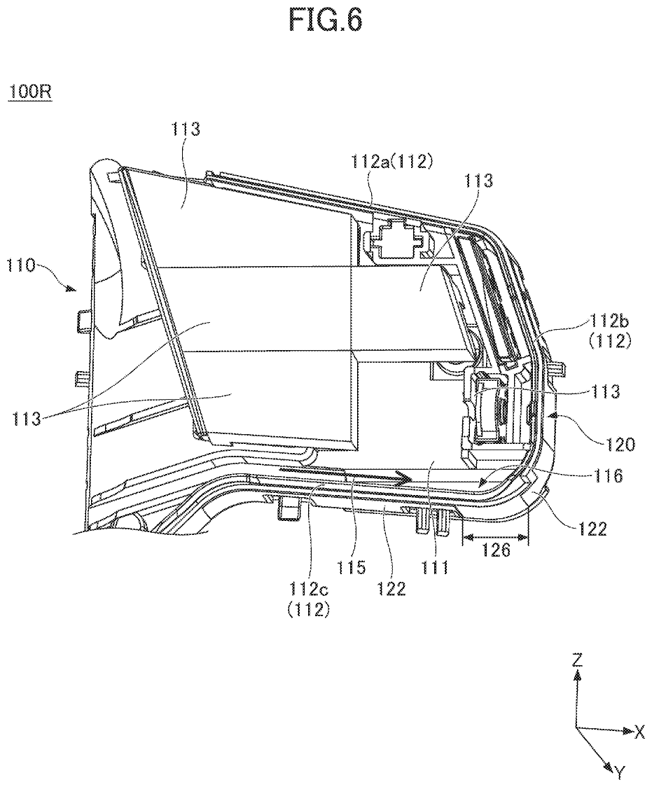

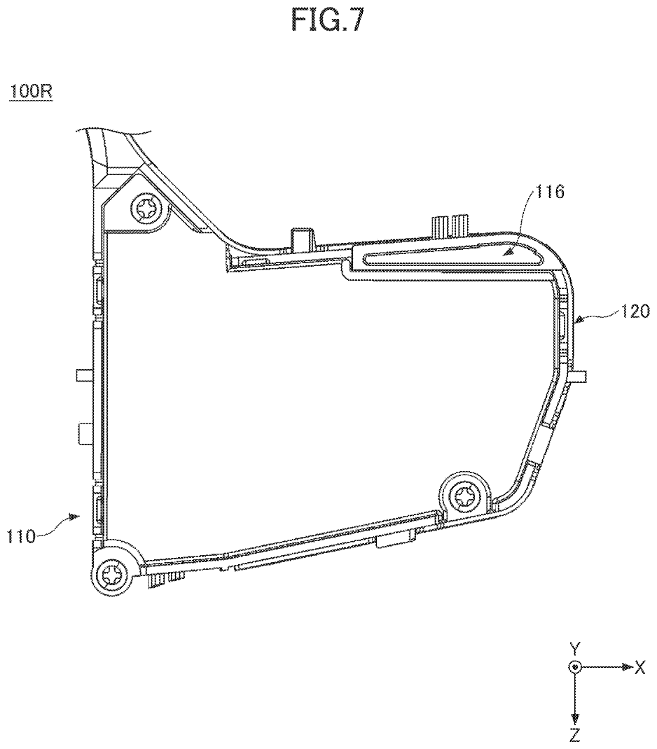

FIG. 6 is a partially enlarged perspective view of the detection device 100R according to the present embodiment. FIG. 7 is a plan view of the detection device 100R according to the present embodiment when viewed from the positive Y-axis direction.

As illustrated in FIG. 6, in the housing 110 of in the detection device 100R, a drainage path 115 for discharging water that has reached the surface of the driver-facing wall portion 111 is provided on the surface of the driver-facing wall portion 111.

On the surface of the driver-facing wall portion 111, the drainage path 115 is provided along the lower wall portion 112c of the outer peripheral wall portion 112 of the housing 110. The lower wall portion 112c is inclined downward to the right with respect to a horizontal plane horizontal to the ground (a horizontal plane parallel to the X-axis) when the steering device 10 is in a neutral steering position. For this reason, water that has entered through a gap between a panel (not illustrated), which covers the driver-facing wall portion 111 and the electrostatic detector 120, and the operation knobs 113 and has reached the surface of the driver-facing wall portion 111 flows in the direction of the lower wall portion 112c according to gravity, and further flows along the lower wall portion 112c toward the lower right corner (the corner on the positive X-axis side and the negative Z-axis side) of the driver-facing wall portion 111 downstream of the drainage path 115 (the arrow (115) indicates the flow direction of water).

In the lower right corner of the driver-facing wall portion 111, there is formed a drainage hole 116 that penetrates the interior of the housing 110 in the front-rear direction (Y-axis direction) and has a flat shape (short in the Z-axis direction and long in the X-axis direction) in a plan view from the Y-axis direction. In other words, the drainage hole 116 is formed on the drainage path 115 in the most downstream direction in the direction of gravity. The shape of the drainage hole 116 is not limited to the above-described flat substantially triangular shape, and can be any shape such as an ellipse shape or a square shape according to the space. The drainage path 115 and the drainage hole 116 are provided between the outer peripheral wall portion 112 and the operation knobs 113. As long as the drainage path 115 and the drainage hole 116 remain separated from the detection electrode 122 and the active shield electrode 124, their arrangement is not restricted. For example, the drainage path 115 and the drainage hole 116 can be positioned directly beneath the operation knob 113.

With the drainage hole 116, in the detection device 100R, when the operation surface 100A is exposed to water, water that has entered through the gap in the operation surface 100A and has reached the surface of the driver-facing wall portion 111 flows downstream along the drainage path 115 according to gravity, and can be discharged to the back surface side (positive Y-axis side) of the housing 110 from the drainage hole 116, which is located at the most downstream side of the drainage path 115.

In the vicinity of the drainage hole 116, the outer peripheral wall portion 112 (the lower wall portion 112c and the right wall portion 112b) of the housing 110 is provided so as to surround the lower side (negative Z-axis side) and the right side (positive X-axis side) of the drainage hole 116. On the outer surface of the outer peripheral wall portion 112, the electrostatic detector 120 having the detection electrode 122 for detecting gripping of the grip portion 13R by the driver's right hand is provided.

Herein, when water that has reached the surface of the driver-facing wall portion 111 adheres to the electrostatic detector 120, the water and the detection electrode 122 are capacitively coupled, and there is a possibility that noise components may be included in the electrostatic capacitance detected by the detection electrode 122.

However, in the electrostatic detector 120 of the present embodiment, when the operation surface 100A is exposed to water, water that has reached the surface of the driver-facing wall portion 111 can be guided to the drainage hole 116 along the drainage path 115 and discharged from the drainage hole 116 to the rear side (positive Y-axis side) of the housing 110, without water adhering to the electrostatic detector 120. Therefore, the electrostatic detector 120 of the present embodiment can prevent water, when the operation surface 100A is exposed to water, that has reached the surface of the driver-facing wall portion 111 from adhering to the electrostatic detector 120.

When water flowing through the drainage path 115 remains on the inner wall of or in the vicinity of the drainage hole 116, water and the detection electrode 122 are capacitively coupled, and there is a possibility that noise components may be included in the capacitance detected by the detection electrode 122.

However, since the active shield electrode 124 is provided on the rear side (i.e., the drainage hole 116 side) of the detection electrode 122 in the electrostatic detector 120 of the present embodiment, the active shield electrode 124 can shield the capacitive coupling of water remaining on the inner wall of or the vicinity of the drainage hole 116 to the detection electrode 122.

As illustrated in FIG. 6, the electrostatic detector 120 of the present embodiment includes a gap portion 126 in which the detection electrode 122 is not provided, in a region overlapping the outer peripheral wall portion 112 at the lower right corner portion of the housing 110, where the drainage hole 116 is provided.

With the gap portion 126, in the electrostatic detector 120 of the present embodiment, the detection electrode 122 can be sufficiently separated from water remaining on the inner wall of or in the vicinity of the drainage hole 116, thereby preventing such water from flowing around and along the outer periphery of the active shield electrode 124 and capacitively coupling with the detection electrode 122.

In the electrostatic detector 120 of the present embodiment, the width of the detection electrode in the Y-axis direction is designed to be smaller than the width of the active shield electrode 124 in the Y-axis direction, as a whole.

With this design, in the electrostatic detector 120 of the present embodiment, it is possible to prevent water remaining on the inner wall of or in the vicinity of the drainage hole 116 from flowing around and along the outer periphery of the active shield electrode 124 and capacitively coupling with the detection electrode 122.

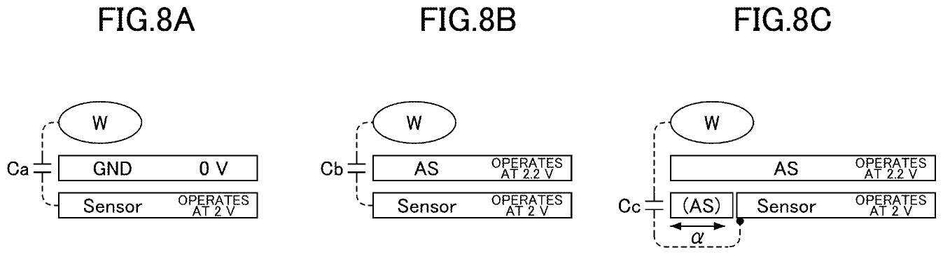

As illustrated in FIG. 8C, which will be described later, a second active shield electrode (depicted as “AS”) adjacent to the detection electrode 122 (depicted as “Sensor”) may be further provided in the gap portion 126. With the second active shield electrode, it is possible to further prevent water remaining on the inner wall of or in the vicinity of the drainage hole 116 from capacitively coupling with the detection electrode 122 through the gap portion 126.

### COMPARATIVE EXAMPLE

Hereinafter, an example of the electrostatic detector 120 according to the present embodiment and a comparative example will be described with reference to FIGS. 8A through 8C. FIG. 8A is a diagram illustrating a comparative example for the electrostatic detector 120 according to the present embodiment, and schematically illustrates a configuration of an electrostatic detector using a self-capacitance method without an active shield (AS). FIG. 8B schematically illustrates a configuration (a configuration without the gap portion 126) of a first example of the electrostatic detector 120 according to the present embodiment using a self-capacitance method of a type having an active shield electrode (AS). FIG. 8C schematically illustrates a configuration (a configuration having the gap portion 126) of a second example of the electrostatic detector 120 according to the present embodiment using a self-capacitance system of the type having an active shield electrode (AS), and corresponds to the present embodiment illustrated in FIGS. 1 through 7.

In the configuration of the electrostatic detector illustrated in FIG. 8A, the electrostatic capacitance Ca capacitively coupled from the water (W) to the detection electrode is obtained by the following Expression (1), when the dielectric constant of the dielectric is ϵ, the area S of the water (W) is “1”, and the distance D from the water (W) to the end of the detection electrode (Sensor) is “1”.

Ca=ϵ×(S/D)=ϵ(1/1)=ϵ Expression (1)

Herein, the amount of charge Qa detected by the detection electrode is obtained by the above Expression (1) and the following Expression (2), when the operating voltage of the detection electrode is 2 V and the potential difference between the GND and the detection electrode (Sensor) is 2 V.

Qa=CaV=Ca*(2−0)=2Ca=2ϵ Expression (2)

Therefore, the degree of influence of the capacitance of the water (W) on the detection electrode is “2”.

In the configuration of the first example of the electrostatic detector 120 illustrated in FIG. 8B, similarly to FIG. 8A, the capacitance Cb capacitively coupled from the water (W) to the detection electrode 122 is obtained by the following Expression (3) when the dielectric constant of the dielectric is ϵ, the area S of the water (W) is “1”, and the distance D from the water (W) to the end of the detection electrode is “1”.

Cb=ϵ×(S/D)=ϵ(1/1)=ϵ Expression (3)

Herein, when the operating voltage of the detection electrode 122 (Sensor) is 2 V and the operating voltage of the active shield electrode 124 (AS) is 2.2 V, and the potential difference between the active shield electrode 124 (AS) and the detection electrode 122 (Sensor) is −0.2 V, the amount of charge Qb detected by the detection electrode 122 (Sensor) is obtained by the above Expression (3) and the following Expression (4).

Qb=CbV=Cb*(2−2.2)=−0.2Cb=−0.2ϵ Expression (4)

Therefore, the degree of influence of the capacitance of the water (W) on the detection electrode is 0.2, namely 1/10 of the configuration without the active shield electrode 124 (AS) illustrated in FIG. 8A.

In the configuration of the second example of the electrostatic detector 120 illustrated in FIG. 8C, the dielectric constant of the dielectric is ϵ and the area S of the water (W) is 1, as in FIG. 8A, but when the distance from the water (W) to the end of the detection electrode is a distance obtained by adding the distance D “1” and the width α “1” of the gap portion 126, the capacitance Cc capacitively coupled from the water (W) to the detection electrode 122 (Sensor) is obtained by the following Expression (5):

Cc=ϵ×(S/(D+α))=ϵ(1/(1+1)=0.5ϵ Expression (5)

Herein, when the operating voltage of the detection electrode 122 (Sensor) is 2 V and the operating voltage of the active shield electrode 124 (AS) is 2.2 V, and the potential difference between the active shield electrode 124 (AS) and the detection electrode 122 (Sensor) is −0.2 V, the amount of charge Qc detected by the detection electrode 122 (Sensor) is obtained by the above Expression (5) and the following Expression (6).

Qc=CcV=Cc*(2−2.2)=−0.2Cc=−0.1ϵ Expression (6)

Therefore, the degree of influence of the capacitance of water (W) on the detection electrode becomes “0.1”, that is, 1/20 as compared with the configuration without the active shield electrode 124 (AS) illustrated in FIG. 8A.

The set values of the parameters S, D, and α used in the above examples are used as reference values in a simplified manner to facilitate understanding of the effect, and are not limited to these set values, and the set values of the parameters S, D, and α are variable. However, regardless of the set values of the parameters S, D, and α, it is clear that the configurations of the first and second examples of the electrostatic detector 120 according to the present embodiment are less influenced by water (W) than the configuration of the electrostatic detector without the active shield electrode 124 (AS) in any case.

### Advantageous Effects

As described above, the steering device 10 according to the present embodiment includes the rim portion 13 configured to be gripped by a driver, the spoke portion 14 disposed adjacent to the rim portion 13, and the electrostatic detector 120 configured to detect a state of gripping of the rim portion 13 by the driver based on a change in capacitance. The electrostatic detector 120 includes the detection electrode 122 and the active shield electrode 124, and both of the detection electrode 122 and the active shield electrode 124 are provided in the spoke portion 14 so as to face the rim portion 13. The spoke portion 14 is provided with the drainage path 115 configured to guide water to the drainage hole 116 when the spoke portion 14 is exposed to water. The drainage hole 116, the active shield electrode 124, the detection electrode 122, and the rim portion 13 are arranged, in this order, from a region in the vicinity of the drainage hole 116 toward the rim portion 13. A base having a sheet-like shape, flexibility, and insulating properties is stacked between the detection electrode and the active shield electrode of the electrostatic detector. The base is composed of at least an intermediate member made of rubber.

Thus, in the steering device 10 according to the present embodiment, even if water adheres to the inner wall or the vicinity of the drainage hole 116 of the drainage path 115 and remains, the active shield electrode 124 can cancel the influence of the remaining water, so that the driver's gripping state can be accurately detected.

In the steering device 10 according the present embodiment, the electrostatic detector 120 is provided in the spoke portion 14 and serves as the detection device 100 having the housing 110.

Thus, the steering device 10 according to the present embodiment can detect the driver's gripping state simply by mounting the detection device 100 on the spoke portion 14 without requiring any substantial modification to the steering wheel 12.

In the steering device 10 according to the present embodiment, the detection electrode 122 and the active shield electrode 124 are provided on an outer periphery of the housing 110 of the detection device 100, and the drainage hole 116 is separated from the detection electrode 122 and the active shield electrode 124 and is provided to penetrate an inside of the housing 110. The electrostatic detector is provided with a gap portion in which the detection electrode is not provided, in a region in the vicinity of the drainage hole. The drainage hole, the active shield electrode, the active shield electrode, and the rim portion are arranged in the gap portion, in this order, toward the rim portion.

Thus, in the steering device 10 according to the present embodiment, the detection electrode 122 is provided in the outer peripheral wall portion 112 (outer peripheral portion) of the housing 110 so as to easily detect the gripping state of the driver, and the drainage hole 116 is provided in the interior of the housing 110 so as not to interfere with the detection electrode 122, so that the detection electrode 122 and the drainage hole 116 can be arranged with space efficiency.

In the steering device 10 according to the present embodiment, the detection device 100 has a plurality of switches (switch input function).

Thus, the steering device 10 according to the present embodiment can function as both the switch input function and the housing 110 of the electrostatic detector 120, and thus the space efficiency is improved.

In the steering device 10 according to the present embodiment, the drainage path 115 is configured to guide the water to the drainage hole 116 when the steering device 10 is in a neutral steering position.

Thus, the steering device 10 according to the present embodiment can reliably discharge water when the steering device is exposed to water when the steering device is in a neutral steering position, which is the most probable state.

In the detection device 100 according to the present embodiment, the detection device 100 is provided in the spoke portion 14 of the steering device 10. The steering device 10 includes the rim portion 13 configured to be gripped by the driver, and the spoke portion 14 disposed adjacent to the rim portion 13. The detection device 100 includes the housing 110 and the electrostatic detector 120 configured to detect a state of gripping of the rim portion 13 by the driver based on a change in capacitance. The electrostatic detector 120 includes the detection electrode 122 and the active shield electrode 124, and both the detection electrode 122 and the active shield electrode 124 are provided in the housing so as to face the rim portion 13. The housing 110 is provided with the drainage path 115 configured to guide water to the drainage hole 116 when the housing 110 is exposed to water. The drainage hole 116, the active shield electrode 124, and the detection electrode 122 are arranged, in this order, from a region in the vicinity of the drainage hole 116 toward the rim portion 13. A base having a sheet-like shape, flexibility, and insulating properties is stacked between the detection electrode and the active shield electrode of the electrostatic detector. The base is composed of at least an intermediate member made of rubber.

Thus, the detection device 100 according to the present embodiment can detect a gripping of the rim portion 13 by the driver simply by being mounted on the spoke portion 14 without requiring any substantial modification to the steering wheel 12.

Although one embodiment of the present invention has been described in detail above, the present invention is not limited to these embodiments, and various alterations or changes may be made within the scope of the present invention described in the appended claims.

What is claimed is:

1. A steering device comprising:
a rim portion configured to be gripped by a driver;
a spoke portion disposed adjacent to the rim portion; and
an electrostatic detector configured to detect a state of gripping of the rim portion by the driver based on a change in capacitance, wherein
the electrostatic detector includes a detection electrode and an active shield electrode, both of the detection electrode and the active shield electrode being provided in the spoke portion so as to face the rim portion,
the spoke portion is provided with a drainage path configured to guide water to a drainage hole when the spoke portion is exposed to water,
the drainage hole, the active shield electrode, the detection electrode, and the rim portion are arranged, in this order, from a region in the vicinity of the drainage hole toward the rim portion,
a base having a sheet-like shape, flexibility, and insulating properties is stacked between the detection electrode and the active shield electrode of the electrostatic detector, and
the base is composed of at least an intermediate member made of rubber.

2. The steering device according to claim 1, wherein
the electrostatic detector is provided in the spoke portion and serves as a detection device having a housing.

3. The steering device according to claim 2, wherein
the detection electrode and the active shield electrode are provided on an outer periphery of the housing of the detection device,
the drainage hole is separated from the detection electrode and the active shield electrode and is provided to penetrate an inside of the housing,
the electrostatic detector is provided with a gap portion in which the detection electrode is not provided, in a region in the vicinity of the drainage hole, and
the drainage hole, the active shield electrode, the active shield electrode, and the rim portion are arranged in the gap portion, in this order, toward the rim portion.

4. The steering device according to claim 2, wherein
the detection device has a switch input function.

5. The steering device according to claim 1, wherein
the drainage path is configured to guide the water to the drainage hole when the steering device is in a neutral steering position.

6. A detection device provided in a spoke portion of a steering device, the steering device including a rim portion configured to be gripped by a driver, and the spoke portion disposed adjacent to the rim portion, the detection device comprising:
a housing; and
an electrostatic detector configured to detect a state of gripping of the rim portion by the driver based on a change in capacitance, wherein
the electrostatic detector includes a detection electrode and an active shield electrode, both of the detection electrode and the active shield electrode being provided in the housing so as to face the rim portion,
the housing is provided with a drainage path configured to guide water to a drainage hole when the housing is exposed to water,
the drainage hole, the active shield electrode, and the detection electrode are arranged, in this order, from a region in the vicinity of the drainage hole toward the rim portion,
a base having a sheet-like shape, flexibility, and insulating properties is stacked between the detection electrode and the active shield electrode of the electrostatic detector, and
the base is composed of at least an intermediate member made of rubber.
